(19) United States
(12) Patent Application Publication
(10) Pub. No.: US 2018/0121027 A1
(43) Pub. Date: May 3, 2018

(54) SCREEN CONTROLLING METHOD AND ELECTRONIC DEVICE THEREOF

(71) Applicant: Samsung Electronics Co., Ltd., Gyeonggi-do (KR)

(72) Inventors: Young-Ri KIM, Gyeonggi-do (KR); Bong-Hee Han, Gyeonggi-do (KR); Yoo-Jin Hong, Gyeonggi-do (KR); Won-Kyu Park, Gyeonggi-do (KR); Yu-Jin Lee, Seoul (KR)

(21) Appl. No.: 15/857,080

(22) Filed: Dec. 28, 2017

Related U.S. Application Data
(63) Continuation of application No. 14/289,189, filed on May 28, 2014.

(30) Foreign Application Priority Data
May 28, 2013 (KR) 10-2013-0060234

(51) Int. Cl. G06F 3/0481; G06F 9/44; G06F 3/0482

(52) U.S. Cl. CPC G06F 3/0481; G06F 9/4443; G06F 3/0482

(57) ABSTRACT

A method of an electronic device includes displaying, by execution of a first application, first data within a first region, the first data being image data, and the first data displayed with a designated aspect ratio, in response to detecting an event, displaying an icon superimposed on the displayed first data, the icon being usable for executing a second application distinct from the first application, and in response to detecting a user input on the icon, displaying, within a second region smaller than the first region, the first data with the designated aspect ratio, and displaying, by execution of the second application, second data within a third region distinct from the second region, and the second region and the third region included in the first region.

### PRIORITY

This application is a Continuation Application of U.S. patent application Ser. No. 14/289,189, filed on May 28, 2014, and claims priority under 35 U.S.C. § 119 to an application filed in the Korean Intellectual Property Office on May 28, 2013 and assigned Serial No. 10-2013-0060234, the contents of each of which are incorporated herein by reference.

### BACKGROUND OF THE DISCLOSURE

### 1. Field of the Disclosure

The present disclosure relates generally to a method and device for controlling a screen in an electronic device, and more particularly, to a technique for guaranteeing the display of other application programs by changing and displaying a display form of an application program fixed to be displayed at the top level of the screen in an electronic device.

### 2. Description of the Related Art

Electronic devices have developed into a multimedia device providing various services such as voice and video call functions, information input/output functions, and data transmission.

When a plurality of application programs are executed, the electronic device displays on a display unit the most recently executed application program. In this case, when it is necessary to switch to an application program executed before a currently displayed application program, a user of the electronic device needs to perform several manipulations. In order to avoid the above inconvenience, the electronic device provides a function fixing a specific application program to be displayed at the top level of the display screen.

However, referring to FIG. 1A, while an Internet application program 101 and a memo application program 121 are fixed to be displayed at the top level as shown in FIG. 1A, if a schedule application program icon 153 is executed by a user's request as shown in FIG. 1B, the schedule application program 171 is hidden by the Internet application program 101 and the memo application program 121 as shown in FIG. 1C. At this point, in order for the user of the electronic device to use the schedule application program 171, the display of the Internet application program 101 and the memory application program 121 needs to be released first.

Accordingly, there is a need for an electronic device which controls application programs fixed to be displayed at the top level of a display screen.

### SUMMARY OF THE DISCLOSURE

The present disclosure has been made to address at least the above problems and/or disadvantages described above and to provide at least the advantages described below. Accordingly, an aspect of the present disclosure is to provide a device and method for controlling a screen in an electronic device.

Another aspect of the present disclosure is to provide a device and method for changing and displaying a display form of an application program fixed to be displayed at a top level of the screen in an electronic device.

Another aspect of the present disclosure is to provide a device and method for minimizing and displaying an application program fixed to be displayed at a top level of the screen in an electronic device.

Another aspect of the present disclosure is to provide a device and method for controlling a position to change and display a display form of an application program fixed to be displayed at a top level of the screen in an electronic device.

Another aspect of the present disclosure is to provide a device and method for controlling a position to minimize and display an application program fixed to be displayed at a top level of the screen in an electronic device.

Another aspect of the present disclosure is to provide a device and method for displaying a notification on an update history of an application program whose display form is changed and displayed in an electronic device.

Another aspect of the present disclosure is to provide a device and method for displaying a notification on an update history of an application program that is minimized and displayed in an electronic device.

Another aspect of the present disclosure is to provide a device and method for returning to and displaying a previous display state on an application program whose display form is changed and displayed in an electronic device.

Another aspect of the present disclosure is to provide a device and method for returning to and displaying a previous display state on an application program that is minimized and displayed in an electronic device.

According to an aspect of the present disclosure, a method of an electronic device includes displaying, by execution of a first application, first data within a first region, the first data being image data, and the first data displayed with a designated aspect ratio, in response to detecting an event, displaying an icon superimposed on the displayed first data, the icon being usable for executing a second application distinct from the first application, and in response to detecting a user input on the icon, displaying, within a second region smaller than the first region, the first data with the designated aspect ratio, and displaying, by execution of the second application, second data within a third region distinct from the second region, and the second region and the third region included in the first region.

According to another aspect of the present disclosure, an electronic device includes a display, and at least one processor operatively connected with the display, wherein the at least one processor is configured to control the display to display, by execution of a first application, first data within a first region, the first data being image data, and the first data displayed with a designated aspect ratio, in response to detecting an event, control the display to display an icon superimposed on the displayed first data, the icon being usable for executing a second application distinct from the first application, and in response to detecting a user input on the icon, control the display to display, within a second region smaller than the first region, the first data with the designated aspect ratio, and displaying, by execution of the second application, second data within a third region distinct from the second region, and the second region and the third region included in the first region.

### BRIEF DESCRIPTION OF THE DRAWINGS

The above and other aspects, features and advantages of the present disclosure will become more apparent from the following detailed description when taken in conjunction with the accompanying drawings in which:

FIGS. 1A to 1C illustrate a typical screen configuration when another application program instead of an application program displayed at the top layer of the display screen in an electronic device is executed;

FIG. 2 is a block diagram illustrating an electronic device according to an embodiment of the present disclosure;

FIG. 3 is a block diagram illustrating a processor according to an embodiment of the present disclosure;

FIG. 4A is a flowchart illustrating a procedure of displaying a newly executed application program by changing a display form of an application program operating in a top-level display mode in an electronic device according to an embodiment of the present disclosure;

FIG. 4B is a block diagram showing components for performing a procedure of displaying a newly executed application program by changing a display form of an application program operating in a top-level display mode in an electronic device according to another embodiment of the present disclosure;

FIG. 5 is a flowchart illustrating a procedure of displaying a newly executed application program by minimizing the display of an application program operating in a top-level display mode in an electronic device according to another embodiment of the present disclosure;

FIGS. 6A to 6C illustrate a screen configuration of displaying a newly executed application program by minimizing the display of an application program operating in a top-level display mode in an electronic device according to another embodiment of the present disclosure;

FIGS. 7A to 7C illustrate a screen configuration of displaying a newly executed application program by minimizing the display of a plurality of application programs operating in a top-level display mode in an electronic device according to another embodiment of the present disclosure;

FIG. 8 is a flowchart illustrating a procedure for displaying an application program operating in a top-level display mode and a newly executed application program in consideration of a required display area thereof according to an embodiment of the present disclosure;

FIG. 9A to 9C are flowcharts illustrating a screen configuration for displaying an application program operating in a top-level display mode and a newly executed application program in consideration of a required display area thereof according to another embodiment of the present disclosure;

FIG. 10 is a flowchart illustrating a procedure of displaying a newly executed application program by minimizing the display of an application program operating in a top-level display mode in an electronic device according to another embodiment of the present disclosure;

FIGS. 11A to 11C illustrate a screen configuration of displaying a newly executed application program by minimizing the display of a plurality of application programs operating in a top-level display mode in an electronic device according to another embodiment of the present disclosure;

FIG. 12 is a flowchart illustrating a procedure of displaying a newly executed application program by minimizing the display of an application program operating in a top-level display mode in an electronic device according to another embodiment of the present disclosure;

FIGS. 13A to 13C illustrate a screen configuration of displaying a newly executed application program by minimizing the display of a plurality of application programs operating in a top-level display mode in an electronic device according to another embodiment of the present disclosure;

FIG. 14 is a flowchart illustrating a procedure of displaying a newly executed application program by minimizing the display of an application program operating in a top-level display mode in an electronic device according to another embodiment of the present disclosure; and

FIGS. 15A to 15B illustrate a screen configuration of displaying a newly executed application program by minimizing the display of a plurality of application programs operating in a top-level display mode in an electronic device according to another embodiment of the present disclosure.

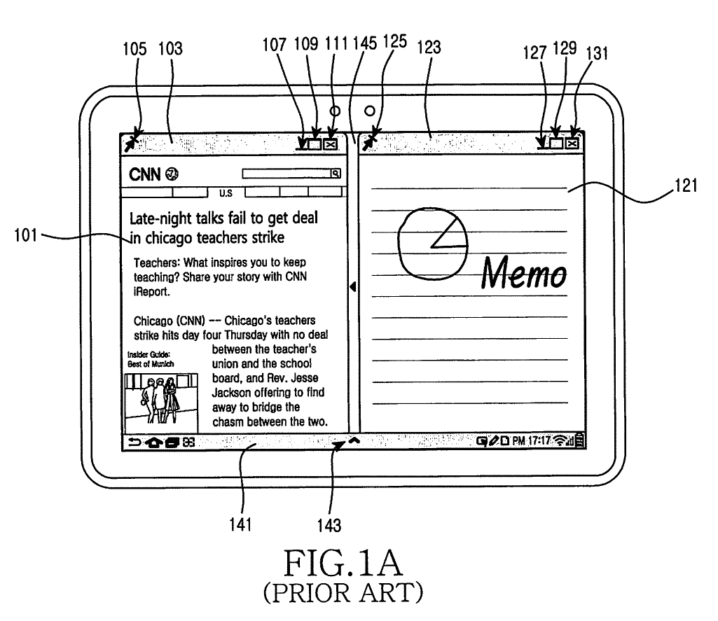

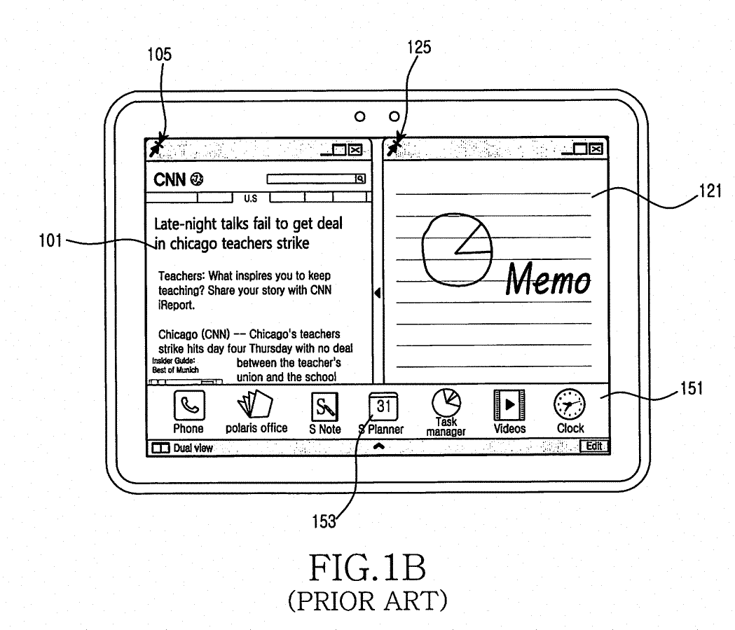

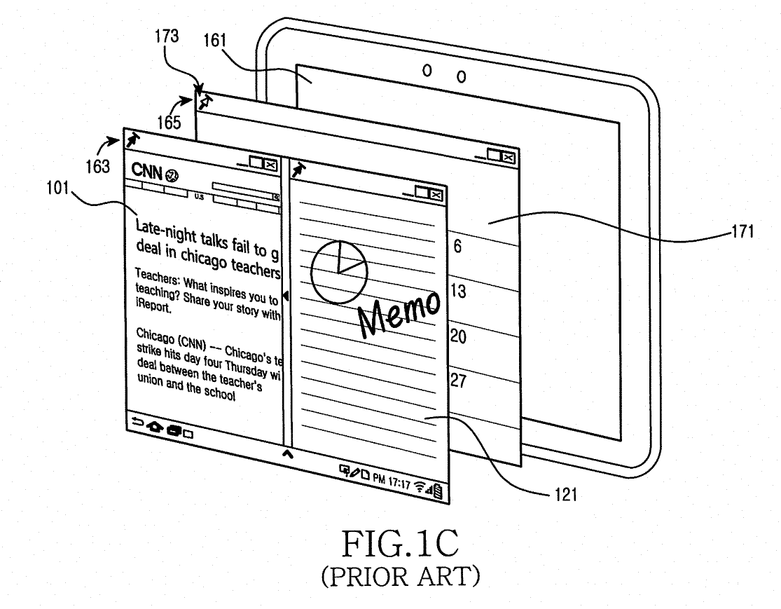

### DETAILED DESCRIPTION OF EMBODIMENTS OF THE PRESENT DISCLOSURE

Embodiments of the present disclosure will be described herein below with reference to the accompanying drawings. In the following description, detailed descriptions of well-known functions or constructions will be omitted since they would obscure the disclosure in unnecessary detail. Also, the terms used herein are defined according to the functions of the present disclosure. Thus, the terms may vary depending on a user's or operator's intentions or practices. Therefore, the terms used herein must be understood based on the descriptions made herein.

The present disclosure relates to a technique for guaranteeing the display of other application programs by changing and displaying a display form of an application program fixed to be displayed at the top layer of a screen in an electronic device.

An electronic device described below may include a mobile communication terminal, a Personal Digital Assistant (PDA), a laptop, a smart phone, a netbook, a TV, a Mobile Internet Device (MID), an Ultra Mobile PC (UMPC), a tablet PC, a navigator, a digital watch, a refrigerator, and an MP3 player.

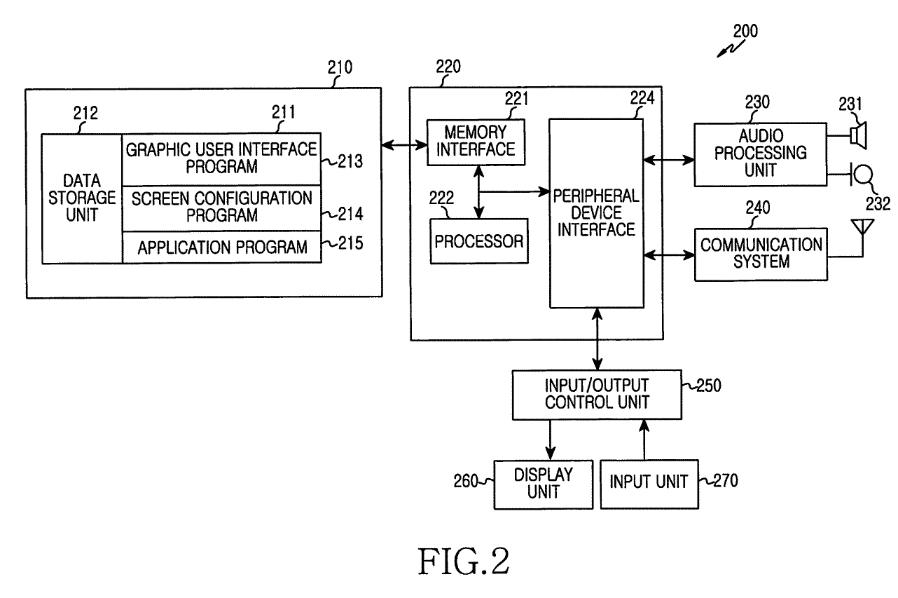

FIG. 2 is a block diagram illustrating an electronic device according to an embodiment of the present disclosure.

As shown in FIG. 2, the electronic device 200 includes a memory 210, a processor unit 220, an audio processing unit 230, a communication system 240, an input/output control unit 250, a display unit 260, and an input unit 270. Here, each component in the electronic device 200 may be provided in plurality.

The memory 210 includes a program storage unit 211 storing a program for controlling an operation of the electronic device 200 and a data storage unit 212 for storing data generated during program execution. For example, the memory 210 may include data indicating whether a top-level display mode on an application program provided from a screen configuration program 214 is set.

The program storage unit 211 includes a graphic user interface (GUI) program 213, the screen configuration program 214, and at least one application program 215. Here, a program included in the program storage unit 211 is a set of commands and may be expressed as a command set.

The GUI program 213 includes at least one software component for providing a GUI to the display unit 260. For example, the GUI program 213 minimizes an application program through the screen configuration program 214 and displays it on the display unit 260. As another example, the GUI program 213 displays a plurality of application programs on the display unit 260 through the screen configuration program 214. As another example, the GUI program 213 displays on the display unit 260 a visual feedback on an application program that is minimized and displayed currently through the screen configuration program 214. As another example, the GUI program 213 displays on the display unit 260 at least one of the name, minimize menu, maximize menu, end menu, and top-level display mode menu on an application program that is minimized and displayed currently through the screen configuration program 214.

The screen configuration program 214 includes at least one software component for displaying an application program operating in the top-level display mode. For example, when a first application program operates in the top-level display mode, the screen configuration program 214 checks whether another application program other than the first application program is executed. If a second application program is executed, the screen configuration program 214 changes and displays a display form of the first application program through the GUI program 213. At this point, the screen configuration program 214 displays the second application program through the GUI program 213. As another example, when the first application program operates in the top-level display mode, the screen configuration program 214 checks whether another application program other than the first application program is executed. If a second application program is executed, the screen configuration program 214 displays the first and second application programs through the GUI program 213 in consideration of a required display area (i.e., a minimum display available area) of the first application program and the second application program.

Additionally, the screen configuration program 214 may include at least one software component for displaying an application program that is minimized and currently displayed. For example, when an update event on an application program whose display form is changed and displayed occurs, the screen configuration program 214 generates an alarm by using at least one of a tactile feedback, an auditory feedback, and a visual feedback. As another example, when a display form return event on an application program whose display form is changed and currently displayed occurs, the screen configuration program 214 changes the application program to be displayed to a previous display form through the GUI program 213. Here, the display form return event may include at least one selection on application program termination besides an application program whose display form is changed and currently displayed and an area where a display form of an application program is changed and displayed.

The application program 215 includes a software component for at least one application program installed in the electronic device 200.

The processor unit 220 includes a memory interface 221, at least one processor 222, and a peripheral device interface 224. Here, the memory interface 220, the at least one processor 221, and the peripheral device interface 123 in the processor unit 120 may be implemented using at least one integrated circuit or separate components.

The memory interface 221 controls components such as the processor 222 or the peripheral device interface 224, to access the memory 210.

The peripheral device interface 224 controls a connection between an input/output peripheral device, the processor 222, and the memory interface 221 of the electronic device 200.

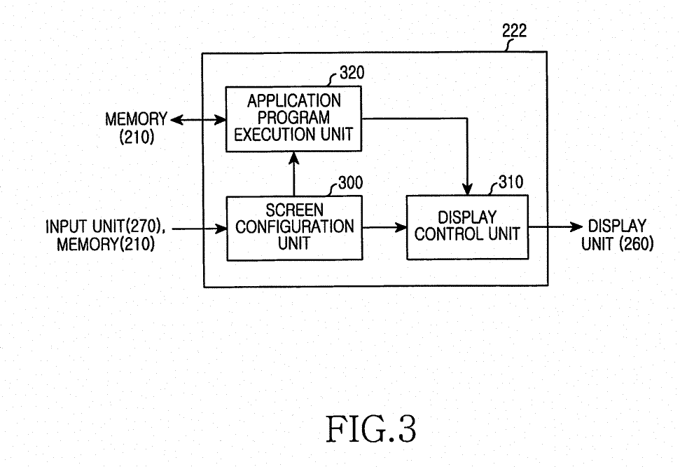

The processor 222 controls the electronic device 200 to provide various services through at least one software program. The processor 222 executes at least one program stored in the memory 210 so as to provide a service according to a corresponding program. For example, the processor 222 may be configured as shown in FIG. 3, so as to execute the screen configuration program 214 and display an application program operating in the top-level display mode.

The audio processing unit 230 provides an audio interface between a user and the electronic device 200 through a speaker 231 and a microphone 232.

The communication system 240 includes at least one software component for performing a communication function for voice communication and data communication. The communication system may be divided into a plurality of communication sub modules supporting different communication networks. For example, the communication network may include a GSM network, an EDGE network, a CDMA network, a W-CDMA network, an LTE network, an OFDMA network, a wireless LAN, a Bluetooth network, and an NFC, but is not limited thereto.

The input/output control unit 250 provides an interface between the input/output device (including the display unit 260 and the input device 270) and the peripheral device interface 224.

The display unit 260 displays state information of the electronic device 200, characters inputted by a user, moving pictures, and still pictures. For example, the display unit 260 displays information on an application program executed by the processor 222. As another example, the display unit 260 minimizes and displays an application program in response to a control of the GUI program 213. As another example, the display unit 260 displays a plurality of application programs in response to a control of the GUI program 213. As another example, the display unit 260 displays a visual feedback on an application program that is minimized and displayed currently in response to a control of the GUI program 213. As another example, the display unit 260 displays at least one of the name, minimize menu, maximize menu, end menu, and top-level display mode menu on an application program that is minimized and displayed currently in response to a control of the GUI program 213.

The input unit 270 provides input data generated by a user's selection to the processor unit 220 through the input/output control unit 250. The input unit 270 may include a keypad including at least one hardware button and a touch pad detecting touch information. For example, the input unit 270 may provide touch information obtained through a touch panel to the processor unit 220 through the input/output control unit 250.

FIG. 3 is a block diagram illustrating a processor according to an embodiment of the present disclosure.

As shown in FIG. 3, the processor 222 may include a screen configuration unit 300, a display control unit 310, and an application program execution unit 320.

The screen configuration unit 300 executes the screen configuration program 214 of the program storage unit 211 to display an application operating in the top-level display mode. For example, when a first application program operates in the top-level display mode, the screen configuration unit 300 checks whether another application program other than the first application program is executed. If a second application program is executed, the screen configuration unit 300 changes and displays a display form of the first application program through the display control unit 310. At this point, the screen configuration unit 300 displays the second application program through the display control unit 310. As another example, when the first application program operates in the top-level display mode, the screen configuration unit 300 checks whether another application program other than the first application program is executed. If the second application program is executed, the screen configuration unit 300 displays the first and second application programs through the display control unit 310 in consideration of a required display area (i.e., a minimum display available area) of the first application program and the second application program.

Additionally, the screen configuration unit 300 controls an application program that is minimized and displayed currently. For example, when an update event on an application program whose display form is changed and displayed occurs, the screen configuration unit 300 generates an alarm by using at least one of a tactile feedback, an auditory feedback, and a visual feedback. As another example, when a display form return event on an application program whose display form is changed and currently displayed occurs, the screen configuration unit 300 changes the application program to be displayed to a previous display form through the display control unit 310. Here, the display form return event may include at least one selection on application program termination besides an application program whose display form is changed and currently displayed and an area where a display form of an application program is changed and displayed.

The display control unit 310 executes the GUI program 213 of the program storage unit 211 to provide a GUI to the display unit 260. For example, the display control unit 310 minimizes an application program through the screen configuration unit 310 and displays it on the display unit 260. As another example, the display control unit 310 displays a plurality of application programs on the display unit 260 through the screen configuration unit 310. As another example, the display control unit 310 displays on the display unit 260 a visual feedback on an application program that is minimized and displayed currently through the screen configuration unit 310. As another example, the display control unit 310 displays on the display unit 260 at least one of the name, minimize menu, maximize menu, end menu, and top-level display mode menu on an application program that is minimized and displayed currently through the screen configuration unit 310.

According to the above-mentioned embodiment, the screen configuration unit 300 executes the screen configuration program 214 to display an application operating in the top-level display mode.

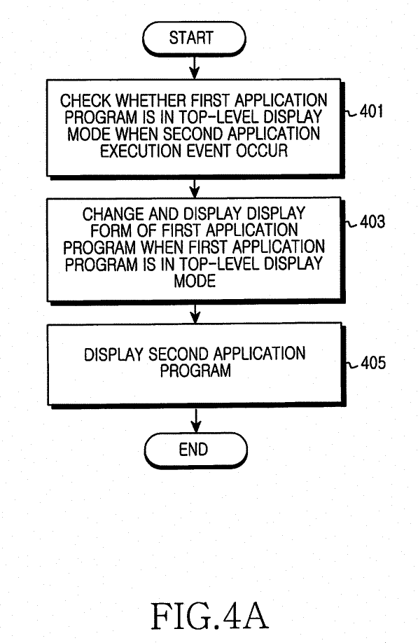

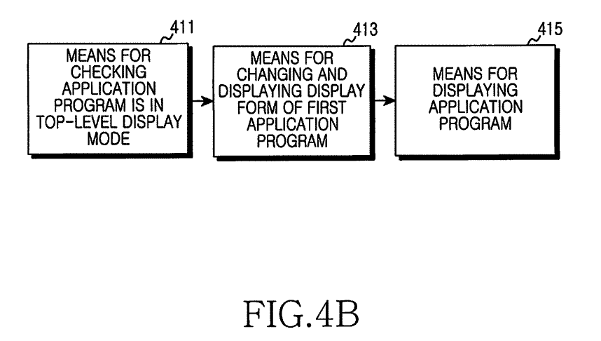

According to another embodiment, an electronic device may include an additional screen configuration module including the screen configuration program 214. FIG. 4A is a flowchart illustrating a procedure of displaying a newly executed application program by changing a display form of an application program operating in a top-level display mode in an electronic device according to an embodiment of the present disclosure.

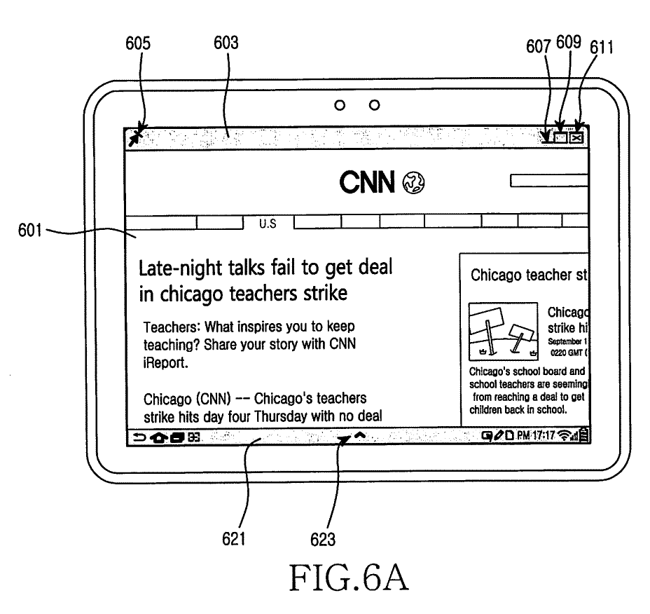

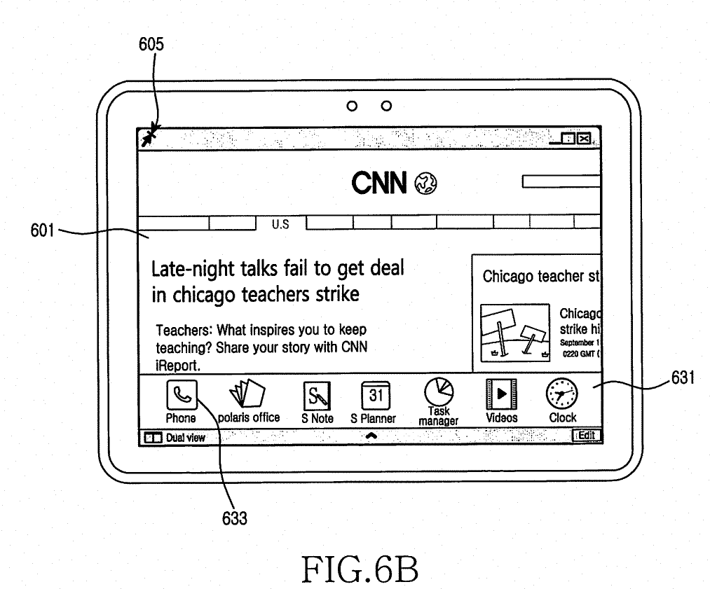

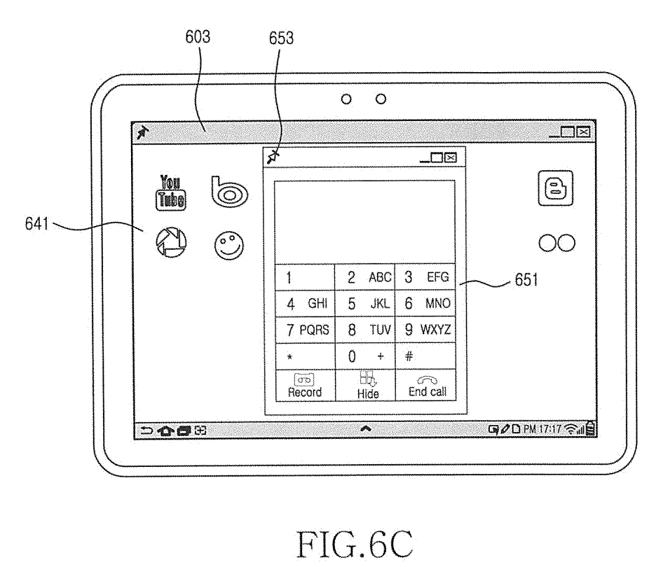

Referring to FIG. 4A, the electronic device displays a first application program, and then, when a second application program execution event occurs, checks whether the first application program is in the top-level display mode in step 401. For example, as shown in FIG. 6A, after an Internet application program 601 is displayed on a display unit, if a selection on an application program list display menu 623 is detected on a status bar 621, the electronic device displays the application program list 631 on the display unit as shown in FIG. 6B. At this point, the electronic device overlaps the application program list 631 while displaying the Internet application program 601. Then, the electronic device checks whether a selection on at least one application program in the application program list 631 is detected. When a selection on a “Phone” 633 is detected from the application program list 631, the electronic device checks whether the Internet application program 601 is in the top-level display mode. If the Internet application program 601 is in the top-level display mode, the electronic device displays an icon 605 on a menu bar 603 of the Internet application program 601.

If the first application program is in the top-level display mode, the electronic device changes and displays a display form of the first application program in step 403. For example, if the Internet application program 601 is in the top-level display mode, as shown in FIG. 6C, the electronic device minimizes the display of the internet application program 601 except for the menu bar 603. At this point, the electronic device minimizes the display of the internet application program and displays a wallpaper 641.

Then, the electronic device displays a second application program in step 405. For example, as shown in FIG. 6C, the electronic device displays a phone application program 651 on the display unit.

Then, the electronic device terminates this algorithm.

As mentioned above, each procedure for displaying an application program operating in the top-level display mode in an electronic device may be configured with a device for displaying an application program operating in the top-level display mode as shown in FIG. 4B.

FIG. 4B is a block diagram showing components for performing a procedure of displaying a newly executed application program by changing a display form of an application program operating in a top-level display mode in an electronic device according to another embodiment of the present disclosure.

Referring to FIG. 4B, the electronic device includes a first means 411 for checking the top-level display mode of an application program, a second means 413 for changing and displaying a display form of an application program, and a third means 415 for displaying an application program.

After displaying the first application program, the first means 411 checks whether the first application program is in the top-level display mode when a second application program execution event occurs. For example, as shown in FIG. 6A, after the Internet application program 601 is displayed on the display unit, if a selection on the application program list display menu 623 is detected an the status bar 621, the electronic device displays the application program list 631 on the display unit as shown in FIG. 6B. At this point, the electronic device overlaps the application program list 631 while displaying the Internet application program 601. Then, the electronic device checks whether a selection on at least one application program in the application program list 631 is detected. When a selection on the “Phone” 633 is detected from the application program list 631, the electronic device checks whether the Internet application program 601 is in the top-level display mode. If the Internet application program 601 is in the top-level display mode, the electronic device displays the icon 605 on the menu bar 603 of the Internet application program 601.

The second means 413 changes and displays a display form of the first application program. For example, if the Internet application program 601 is in the top-level display mode, as shown in FIG. 6C, the electronic device minimizes the display of the Internet application program 601 except for the menu bar 603. At this point, the electronic device minimizes the display of the Internet application program and displays the wallpaper 641.

The third means 415 displays the second application program. For example, as shown in FIG. 6C, the electronic device displays the phone application program 651 on the display unit.

As described above, the electronic device may include each of means 411, 413 and 415 for displaying an application program operating in the top-level display mode. Also, the electronic device may include means 411, 413 and 415 integrated as a single means for displaying an application program operating in the top-level display mode.

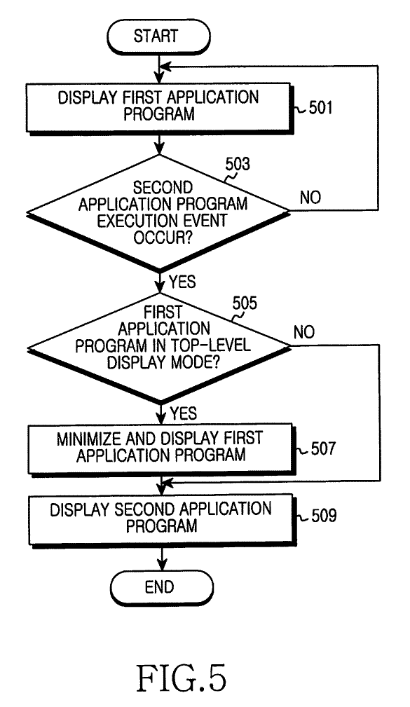

FIG. 5 is a flowchart illustrating a procedure of displaying a newly executed application program by minimizing the display of an application program operating in a top-level display mode in an electronic device according to an embodiment of the present disclosure.

Referring to FIG. 5, the electronic device displays a first application program in step 501. For example, as shown in FIG. 6A, the electronic device displays the Internet application program 601 on the display unit. At this point, the electronic device displays an icon 605 on the menu bar 603 of the Internet application program 601 to indicate whether the Internet application program 601 is in the top-level display mode. Additionally, the electronic device may set or release the top-level mode depending on a selection on the icon 605 indicating the top-level display mode. Moreover, the electronic device displays an icon for minimizing 607, maximizing 609, and closing 611 the display of the Internet application program 601 on the menu bar 603. Here, the top-level display mode includes a setting for placing the position of a display layer of an application program displayed on the display unit first before placing the position of a display layer of another application program.

Then, the electronic device checks whether a second application program execution event occurs in step 503. For example, as shown in FIG. 6A, if a selection on the application program list display menu 623 is detected on the status bar 621, the electronic device displays the application program list 631 on the display unit as shown in FIG. 6B. The electronic device overlaps the application program list 631 to display the Internet application program 601. Then, the electronic device checks whether a selection on at least one application program in the application program list 631 is detected.

If the second application program execution event does not occur in step 503, the electronic device returns to step 501 and displays the first application program. For example, if the second application program execution event does not occur, as shown in FIG. 6A, the electronic device maintains the display of the Internet application program 601.

When the second application program execution event occurs in step 503, the electronic device proceeds to step 505 to check whether the first application program is in the top-level display mode. For example, when a selection on the “Phone” 633 is detected from the application program list 631 as shown in FIG. 6B, the electronic device checks whether the Internet application program 601 is in the top-level display mode. If the Internet application program 601 is in the top-level display mode, the electronic device displays the icon 605 on the menu bar 603 of the Internet application program 601.

If the first application program is not in the top-level display mode in step 505, the electronic device displays the second application program in step 509.

If the first application program is in the top-level display mode in step 505, the electronic device minimizes and displays the first application program in step 507. For example, if the Internet application program 601 is in the top-level display mode, as shown in FIG. 6C, the electronic device minimizes the display of the Internet application program 601 except for the menu bar 603. At this point, the electronic device minimizes the display of the Internet application program and displays the wallpaper 641.

Then, the electronic device displays a second application program in step 509. For example, as shown in FIG. 6C, the electronic device displays the phone application program 651 on the display unit.

Then, the electronic device terminates this algorithm.

Additionally, when the second application program is terminated, the electronic device displays the minimized first application in a display form before the minimization.

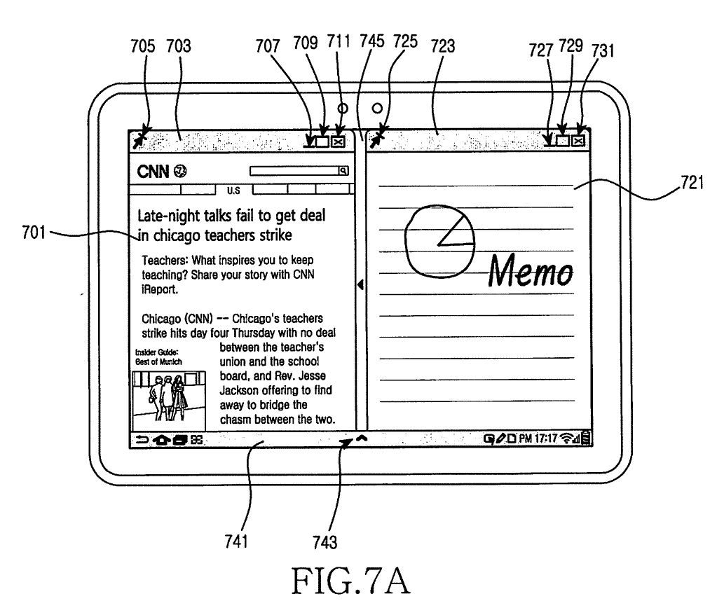

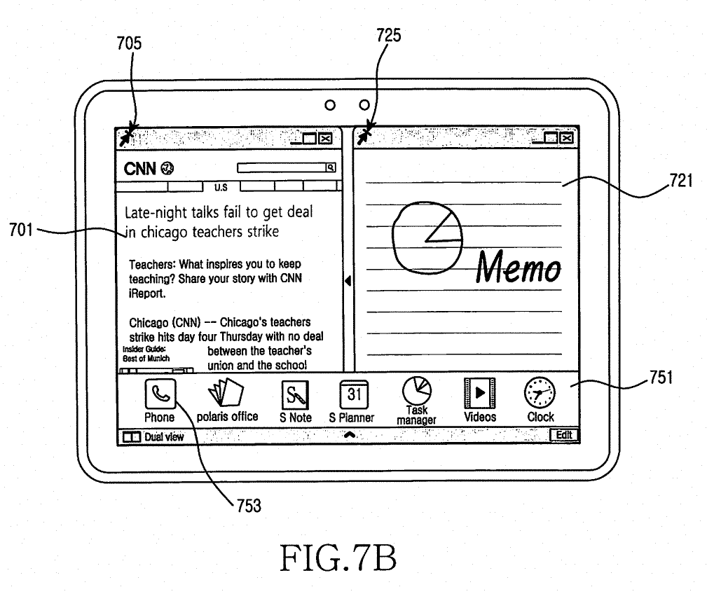

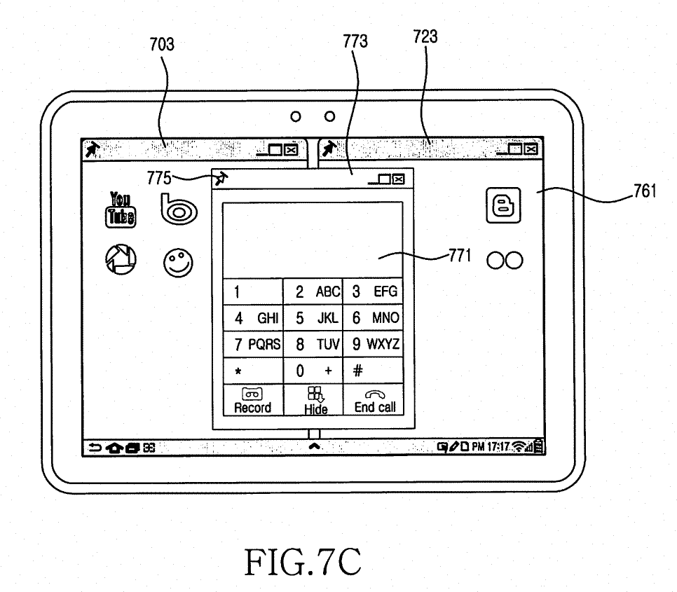

Moreover, as shown in FIGS. 7A to 7C, after displaying a plurality of first application programs in a multi-window environment, the electronic device minimizes and displays the plurality of first application programs and a second application program when an execution event on the second application program occurs. For example, as shown in FIG. 7A, the electronic device displays the Internet application program 701 and a memo application program 721 as a multi-window on the display unit. The electronic device displays an icon 705 on the menu bar 703 of the Internet application program 701 to indicate whether the Internet application program 701 is in the top-level display mode. Additionally, the electronic device may set or release the top-level mode depending on a selection on the icon 705 indicating the top-level display mode.

The electronic device may display an icon on menu bar 703 for minimizing 707, maximizing 709, and closing 711 the display of the Internet application program 701. Moreover, the electronic device displays an icon 725 on the menu bar 723 of the memo application program 721 to indicate whether the memo application program 721 is in the top-level display mode. Additionally, the electronic device may set or release the top-level mode depending on a selection on the icon 725 indicating the top-level display mode. Moreover, the electronic device may display an icon on menu bar 723 for minimizing 727, maximizing 729, and closing 731 the display of the memo application program 721.

Then, as shown in FIG. 7A, if a selection on the application program list display menu 743 is detected on the status bar 741, the electronic device displays the application program list 751 on the display unit as shown in FIG. 7B. At this point, the electronic device overlaps the application program list 751 while displaying the Internet application program 701 and the memo application program 721. When a selection on a “Phone” 753 is detected from the application program list 751, the electronic device checks whether the Internet application program 701 and the memo application program 721 are in the top-level display mode. If the Internet application program 701 and the memo application program 721 are in the top-level display mode, as shown in FIG. 7C, the electronic device minimizes the display of the Internet application program 701 and the memo application program 721 except for the menu bar 703 and the menu bar 723. At this point, the electronic device minimizes the display of the internet application program 701 and displays the wallpaper 761. Then, the electronic device displays a phone application program 771 on the display unit.

According to the above-mentioned embodiment, when at least one application program is in the top-level display mode during execution of the second application, the electronic device minimizes and displays the at least one application program and then displays an additional application program.

According to another embodiment, when the first application program is in the top-level display mode during execution of the second application, the electronic device displays the first application program and displays the second application program simultaneously.

According to another embodiment, when the first application program is in the top-level display mode during execution of the second application, the electronic device displays the second application program and then minimizes and displays the first application program.

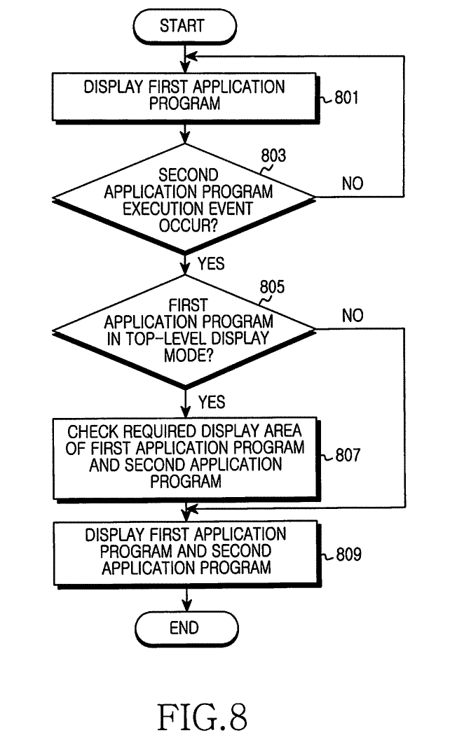

FIG. 8 is a flowchart illustrating a procedure for displaying an application program operating in a top-level display mode and a newly executed application program in consideration of a required display area thereof according to an embodiment of the present disclosure.

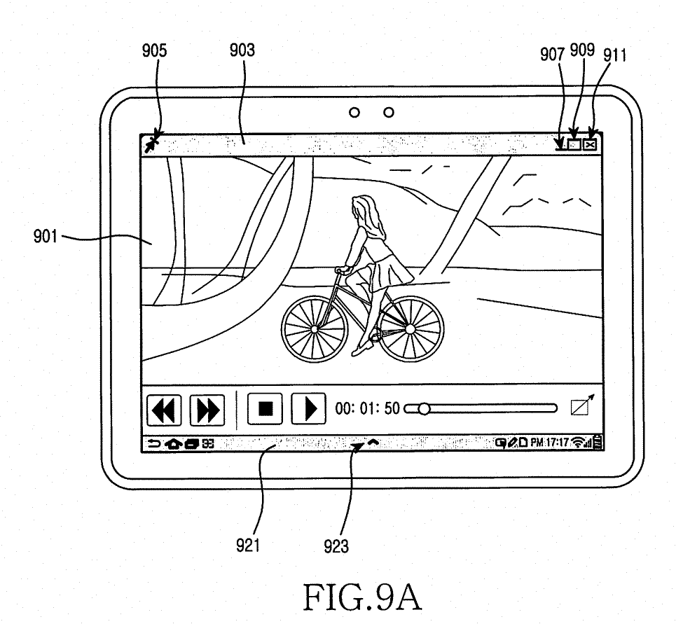

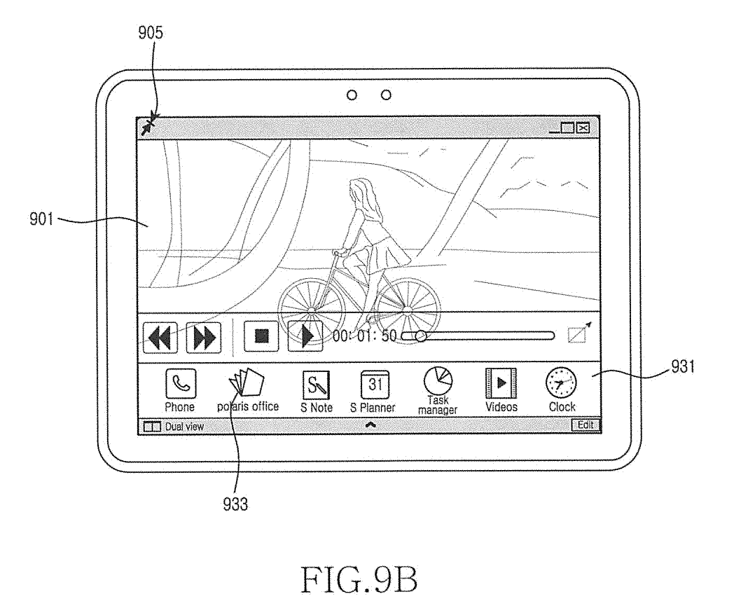

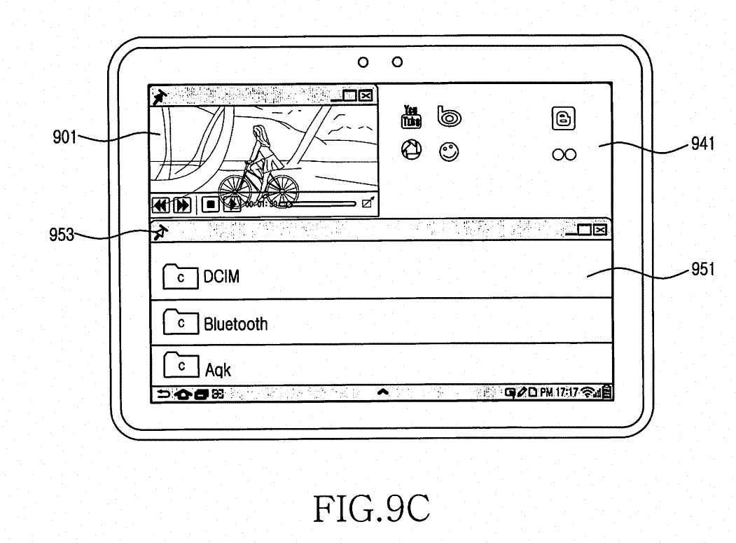

Referring to FIG. 8, the electronic device displays a first application program in step 801. For example, as shown in FIG. 9A, the electronic device displays a video application program 901 on the display unit. At this point, the electronic device displays an icon 905 on the menu bar 903 of the video application program 901 to indicate whether the video application program 901 is in the top-level display mode. Additionally, the electronic device may set or release the top-level mode depending on a selection on the icon 905 indicating the top-level display mode. Moreover, the electronic device may display an icon on menu bar 903 for minimizing 907, maximizing 909, and closing 911 the display of the video application program 901.

Then, the electronic device checks whether a second application program execution event occurs in step 803. For example, as shown in FIG. 9A, if a selection on the application program list display menu 923 is detected on the status bar 921, the electronic device displays the application program list 931 on the display unit as shown in FIG. 9B. At this point, the electronic device overlaps the application program list 931 while displaying the video application program 901. Then, the electronic device checks whether a selection on at least one application program in the application program list 931 is detected.

If the second application program execution event does not occur in step 803, the electronic device returns to step 801. For example, if the second application program execution event does not occur, as shown in FIG. 9A, the electronic device maintains the display of the video application program 901.

When the second application program execution event occurs, the electronic device proceeds to step 805 to check whether the first application program is in the top-level display mode. For example, when a selection on the “office” icon 933 is detected from the application program list 931 as shown in FIG. 9B, the electronic device checks whether the video application program 901 is in the top-level display mode. If the video application program 901 is in the top-level display mode, the electronic device displays the icon 905 on the menu bar 903 of the video application program 901.

If the first application program is not in the top-level display mode in step 805, the electronic device displays the first application program and the second application program in step 809.

If the first application program is in the top-level display mode in step 805, the electronic device checks a required display area of the first application program and the second application program in step 807. Here, the required display area may have the smallest size among various sizes in which an application can be displayed.

After checking the required display area of the first and second application programs, the electronic device displays the first and second application programs in step 809. For example, as shown in FIG. 9C, the electronic device displays the video application program 901 and the file search application program 951 on the display unit.

Then, the electronic device terminates this algorithm.

Additionally, while checking the required display area of the first and second application programs, if it is determined that the first and second application programs cannot be displayed on the display unit simultaneously, the electronic device minimizes the first application program and displays the second application program.

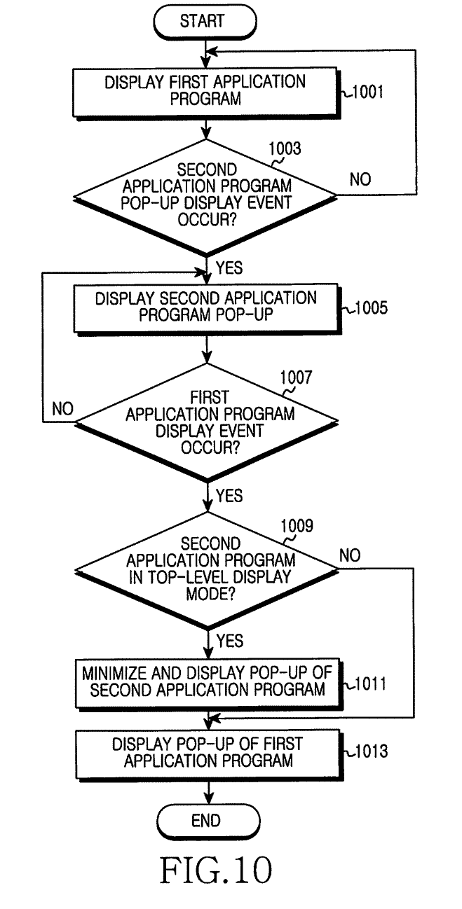

FIG. 10 is a flowchart illustrating a procedure of displaying a newly executed application program by minimizing the display of an application program operating in a top-level display mode in an electronic device according to another embodiment of the present disclosure.

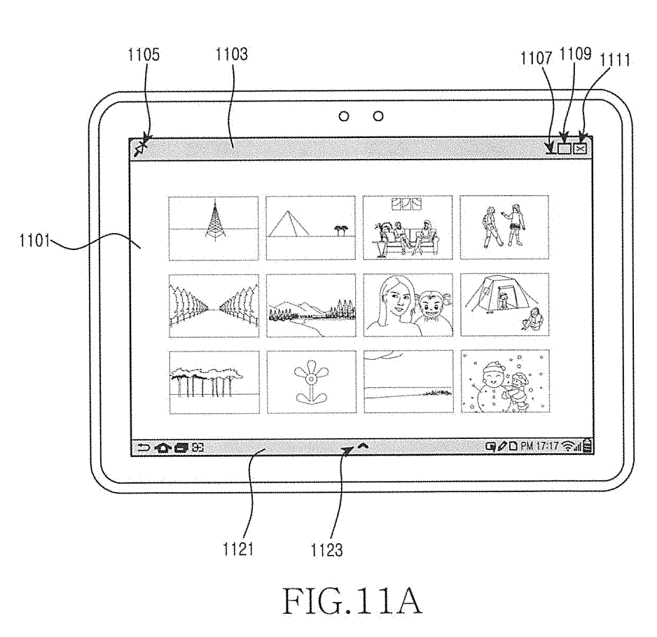

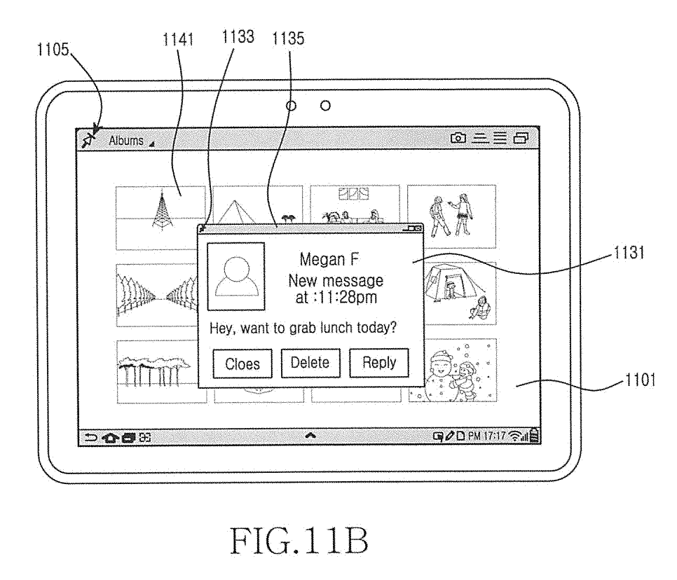

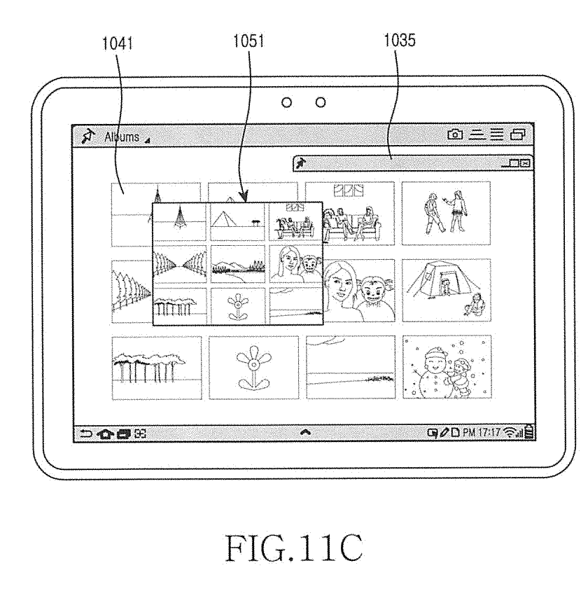

Referring to FIG. 10, the electronic device displays a first application program in step 1001. For example, as shown in FIG. 11A, the electronic device displays a photo album application program 1101 on the display unit. At this point, the electronic device displays an icon 1105 on the menu bar 1103 of the photo album application program 1101 to indicate whether the photo album application program 1101 is in the top-level display mode. Additionally, the electronic device may set or release the top-level mode depending on a selection on the icon 1105 indicating the top-level display mode. Moreover, the electronic device displays an icon for minimizing 1107, maximizing 1109, and closing 1111 the display of the photo album application program 1101 through the menu bar 1103.

Then, the electronic device checks whether a pop-up display event on a second application program occurs in step 1003. If the pop-up display event on the second application program does not occur, the electronic device returns to step 1001 to display the first application program.

If the pop-up display event on the second application program occurs in step 1003, the electronic device displays the pop-up of the second application program in step 1005. For example, as shown in FIG. 11B, the electronic device displays a message application program pop-up 1131 on the photo album application program 1101.

After displaying the pop-up of the second application program, the electronic device checks whether a display event occurs in the first application program in step 1007. For example, as shown in FIG. 11B, after displaying the message application program pop-up 1131, the electronic device checks whether a selection on at least one picture folder is detected in the photo album application program 1101. If a display event does not occur in the first application program, the electronic device maintains the pop-up display of the second application program in step 1005.

When the display event occurs in the first application program, the electronic device checks whether the second application program is in the top-level display mode in step 1009. For example, when a selection on a “first folder” 1141 is detected from the photo album application program 1101 as shown in FIG. 11B, the electronic device checks whether the message application program pop-up 1131 is in the top-level display mode. At this point, if the message application program pop-up 1131 is in the top-level display mode, the electronic device displays the icon 1133 on the menu bar 1135 of the message application program 1131.

If the pop-up of the second application program is not in the top-level display mode in step 1009, the electronic device displays the pop-up of the first application program in step 1013.

Moreover, if the pop-up of the second application program is in the top-level display mode in step 1009, the electronic device minimizes and displays the second application program in step 1011. For example, if the message application program pop-up 1131 is in the top-level display mode, as shown in FIG. 11C, the electronic device minimizes the display of the message application pop-up 1131 except for the menu bar 1135.

Then, the electronic device displays the pop-up of the first application program in step 1013. For example, as shown in FIG. 11C, the electronic device displays on the display unit at least one image 1051 in the folder 1041 selected by the photo album application program.

Then, the electronic device terminates this algorithm.

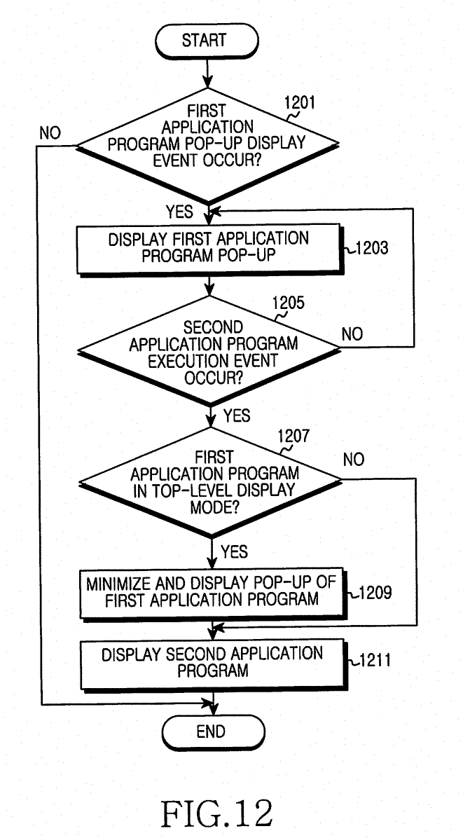

FIG. 12 is a flowchart illustrating a procedure of displaying a newly executed application program by minimizing the display of an application program operating in a top-level display mode in an electronic device according to another embodiment of the present disclosure.

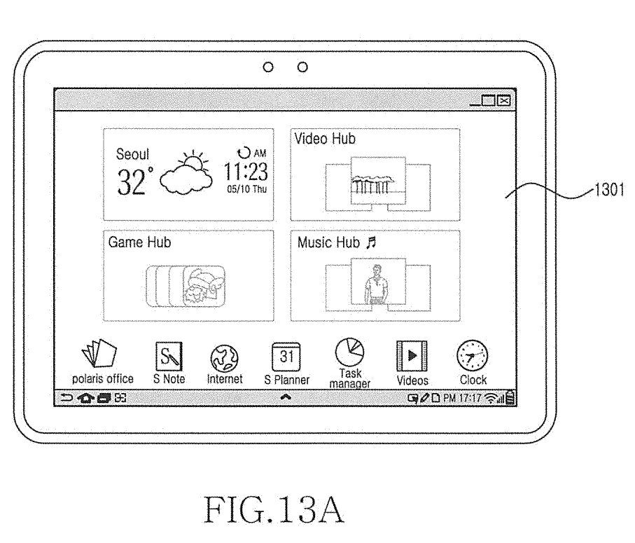

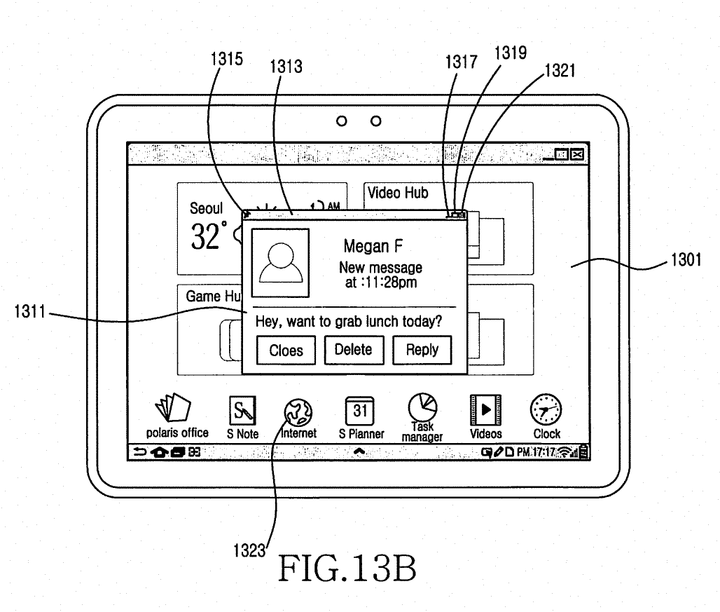

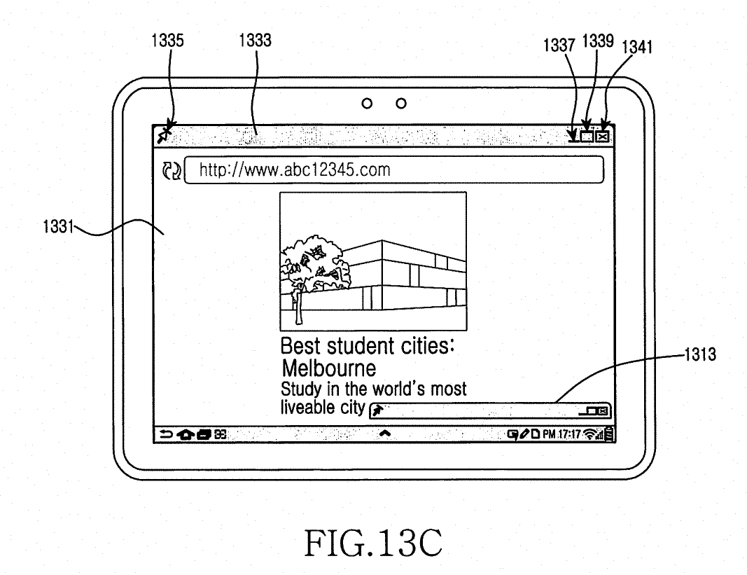

Referring to FIG. 12, the electronic device checks whether a pop-up display event on the first application program occurs in step 1201. For example, as shown in FIG. 13A, the electronic device checks whether a pop-up display event occurs by at least one application program while the wallpaper 1301 is displayed. If the pop-up display event on the first application program does not occur, the electronic device terminates this algorithm.

If the pop-up display event on the first application program occurs, the electronic device displays the pop-up of the first application program in step 1203. For example, as shown in FIG. 13B, the electronic device displays the message application program pop-up 1311. At this point, the electronic device displays an icon 1315 on the menu bar 1313 of the message application program pop-up 1311 to indicate whether the message application program 1311 is in the top-level display mode. Additionally, the electronic device may set or release the top-level mode depending on a selection on the icon 1315 indicating the top-level display mode. Moreover, the electronic device displays an icon for minimizing 1317, maximizing 1319, and closing 1321 the display of the message application program pop-up 1311 on the menu bar 1313.

Then, the electronic device checks whether a second application program execution event occurs in step 1205. For example, as shown in FIG. 13B, the electronic device checks whether a selection on at least one application program in the wallpaper 1301 is detected. If the pop-up display event on the second application program does not occur, the electronic device returns to step 1203 to display the first application program.

Moreover, when the second application program execution event occurs, the electronic device checks whether the first application program is in the top-level display mode in step 1207. For example, as shown in FIG. 13B, when a selection on the “Internet” 1323 icon is detected from the wallpaper 1301, the electronic device checks whether the message application program pop-up 1311 is in the top-level display mode. At this point, if the message application program pop-up 1311 is in the top-level display mode, the electronic device displays the icon 1315 on the menu bar 1313 of the message application program 1311.

If the first application program is not in the top-level display mode in step 1207, the electronic device displays the second application program in step 1211.

Moreover, if the first application program is in the top-level display mode in step 1207, the electronic device minimizes and displays the first application program pop-up in step 1209. For example, if the message application program pop-up 1311 is in the top-level display mode, as shown in FIG. 13C, the electronic device minimizes the display of the message application pop-up 1311 except for the menu bar 1313.

Then, the electronic device displays the second application program in step 1211. For example, as shown in FIG. 13C, the electronic device displays the Internet application program 1331 on the display unit.

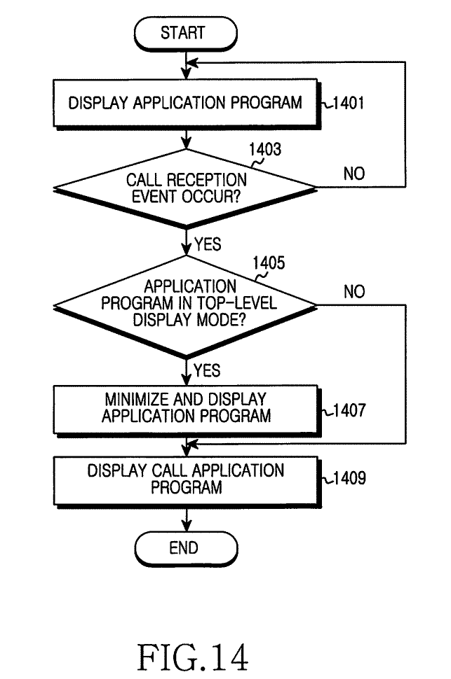

Then, the electronic device terminates this algorithm FIG. 14 is a flowchart illustrating a procedure of displaying a newly executed application program by minimizing the display of an application program operating in a top-level display mode in an electronic device according to another embodiment of the present disclosure.

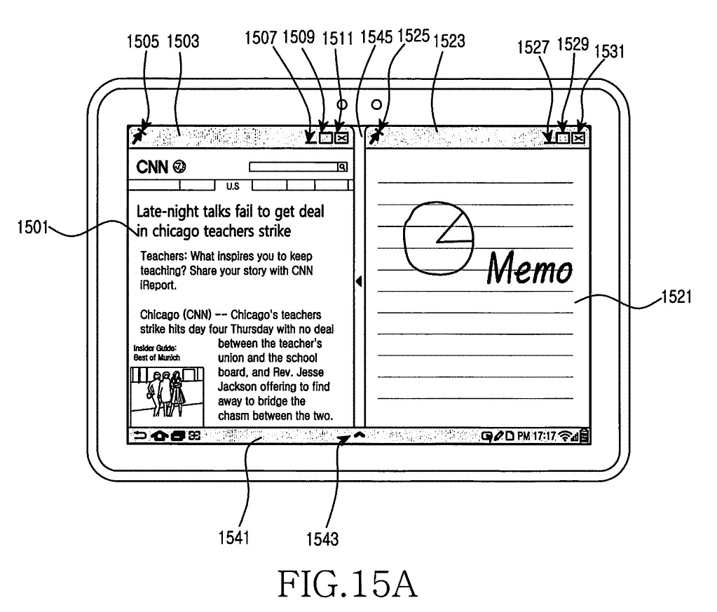

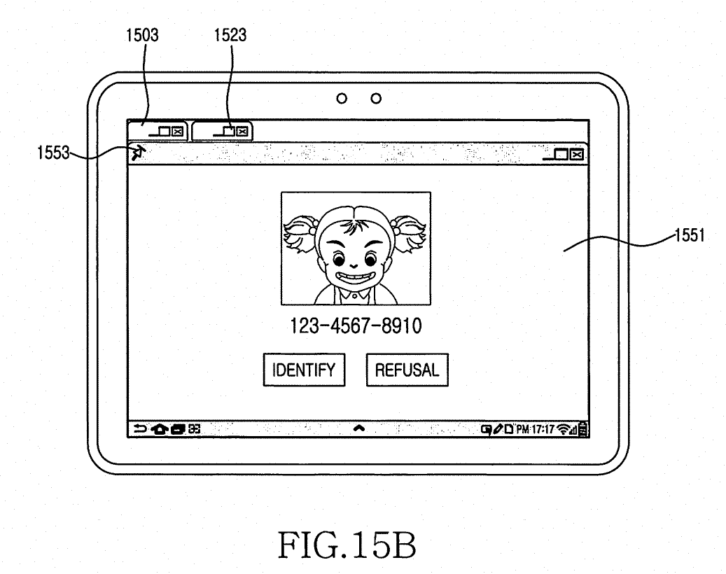

Referring to FIG. 14, the electronic device displays an application program in step 1401. For example, as shown in FIG. 15A, the electronic device displays the Internet application program 1501 and the memo application program 1521 as a multi-window on the display unit. At this point, the electronic device displays an icon 1505 on the menu bar 1503 of the Internet application program 1501 to indicate whether the Internet application program 1501 is in the top-level display mode. Additionally, the electronic device may set or release the top-level mode depending on a selection on the icon 1505 indicating the top-level display mode. Moreover, the electronic device displays an icon for minimizing 1507, maximizing 1509, and closing 1511 the display of the internet application program 1501 on the menu bar 1503.

The electronic device also displays an icon 1525 on the menu bar 1523 of the memo application program 1521 to indicate whether the memo application program 1521 is in the top-level display mode.

Additionally, the electronic device may set or release the top-level mode depending on a selection on the icon 1525 indicating the top-level display mode. Moreover, the electronic device displays an icon for minimizing 1527, maximizing 1529, and closing 1531 the display of the memo application program 1521 on the menu bar 1523.

After displaying an application program, the electronic device checks whether a call reception event occurs in step 1403. If the call reception event does not occur, the electronic device returns to step 1401 to display the application program in step 1401.

When the call reception event occurs, the electronic device checks whether the application program is in the top-level display mode in step 1405.

If the application program is not in the top-level display mode in step 1405, the electronic device displays the call information received through a call application program 1551 in step 1409.

If the application program is in the top-level display mode in step 1405, the electronic device minimizes and displays the application program in step 1407. For example, if the Internet application program 1501 is in the top-level display mode, as shown in FIG. 15B, the electronic device minimizes the display of the Internet application program 1501 except for the menu bar 1503. Moreover, if the memo application program 1521 is in the top-level display mode, as shown in FIG. 15B, the electronic device also minimizes the display of the memo application program 1521 except for the menu bar 1523.

Then, the electronic device displays call information received through the call application program 1551 in step 1409.

Then, the electronic device terminates this algorithm.

According to the above-mentioned embodiment, although the call application program is used as an application program having a priority, the electronic device may include an application program having a priority by a user such as an alarm and a timer.

Moreover, according to the above-mentioned embodiment, the electronic device minimizes the display of an application program except for the menu bar of the application program. At this point, when there are updated details in the minimized application program, the electronic device may display the menu bar of the minimized application program by using a visual change (for example, color change and brightness change). In addition, the electronic device may output the updated details of the minimized application program through sound. Additionally, the electronic device may generate an alarm when there are the updated details of the minimized application program.

In addition, the menu bar of the minimized application program may include at least one of a top-level display mode icon, a minimize icon, a maximize icon, and a close icon. At this point, when a selection on the menu bar of the minimized application program is detected, the electronic device displays the minimized application program in consideration of a previous display state of the minimized application program.

As mentioned above, when another application program other than an application program displayed in the top level is executed in the electronic device, by changing and displaying a display form of the application program displayed in the top level, the display of a newly executed application program may be guaranteed.

It will be appreciated that embodiments of the present disclosure according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage such as, for example, a storage device like a ROM, whether erasable or rewritable or not, or in the form of memory such as, for example, RAM, memory chips, devices or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Accordingly, embodiments provide a program comprising code for implementing an apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the disclosure has been shown and described with reference to certain embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method in an electronic device, the method comprising:
displaying, by execution of a first application, first data within a first region, the first data being image data, and the first data displayed with a designated aspect ratio;
in response to detecting an event, displaying an icon superimposed on the displayed first data, the icon being usable for executing a second application distinct from the first application; and
in response to detecting a user input on the icon, displaying, within a second region smaller than the first region, the first data with the designated aspect ratio, and displaying, by execution of the second application, second data within a third region distinct from the second region, and the second region and the third region included in the first region.

2. The method of claim 1,
wherein the first size is a size of a screen of the electronic device, and
wherein displaying the first data within the first region with the first size comprises displaying the first data in full-screen mode.

3. The method of claim 1,
wherein the first region with the first size is an entire region of a first window with the first size and the second region with the second size is an entire region of a second window with the second size.

4. The method of claim 2,
wherein the image data is moving image data.

5. The method of claim 4, the second size is a minimum size required for displaying the first data with the designated aspect ratio.

6. An electronic device comprising:
a display; and
at least one processor operatively connected with the display;
wherein the at least one processor is configured to:
control the display to display, by execution of a first application, first data within a first region, the first data being image data, and the first data displayed with a designated aspect ratio;
in response to detecting an event, control the display to display an icon superimposed on the displayed first data, the icon being usable for executing a second application distinct from the first application; and
in response to detecting a user input on the icon, control the display to display,
within a second region smaller than the first region, the first data with the designated aspect ratio, and
displaying, by execution of the second application, second data within a third region distinct from the second region, and the second region and the third region included in the first region.

7. The electronic device of claim 6,
wherein the first size is a size of a screen of the electronic device, and
wherein displaying the first data within the first region with the first size comprises displaying the first data in full-screen mode.

8. The electronic device of claim 6,
wherein the first region with the first size is an entire region of a first window with the first size and the second region with the second size is an entire region of a second window with the second size.

9. The electronic device of claim 7,
wherein the image data is moving image data.

10. The electronic device of claim 9,
wherein the second size is a minimum size required for displaying the first data with the designated aspect ratio.
